(19) United States
(12) Patent Application Publication
(10) Pub. No.: US 2005/0122939 A1
(43) Pub. Date: Jun. 9, 2005

(54) ROAMING LOCAL AREA NETWORK

(76) Inventor: Heng-Chien Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,380

(22) Filed: Dec. 9, 2003

(51) Int. Cl. H04Q 7/24

(52) U.S. Cl. 370/338

(57) ABSTRACT

A roaming local area network (LAN) includes a first Internet Protocol (IP) sharing device for sharing connection to a first dynamic IP address, a first group of network devices connected to the first IP sharing device, a second IP sharing device for sharing connection to a second dynamic IP address, and a second group of network devices connected to the second IP sharing device, wherein each network device in the first and second groups of network devices has a unique virtual IP address. A host is connected to the Internet through a static IP address, and the host controls data traffic between the first group of network devices and the second group of network devices.

### BACKGROUND OF INVENTION

1. Field of the Invention

he present invention relates to a local area network (LAN), and more specifically, to a roaming LAN created across the Internet by using dynamic Internet Protocol (IP) addresses.

2. Description of the Prior Art

bk popularity and affordability of computers and networking equipment has led to a tremendous growth of local area networks (LANs). A LAN can be easily created in a small local environment such as a home or an office. The LAN allows all computers to access other computers or network devices within the LAN. A LAN can provide a high degree of privacy and security from outside threats, especially when used in conjunction with a firewall.

On the other hand, when a private network is required between two geographically separated networks, a virtual private network (VPN) may be used. A VPN is a network utilizing the encrypting technology of the Internet Protocol (IP) to establish a virtual tunnel through the Internet in order to form a structure similar to a private network.

Please refer to FIG. 1. FIG. 1 is a functional block diagram of a VPN 10 according to the prior art. The VPN 10 connects a first LAN 26 to a second LAN 30. Both the first LAN 26 and the second LAN 30 contain a plurality of computers 28 and other network devices. Each of the first and second LANs 26 and 30 is connected to each other through an Internet connection 20, such as an xDSL connection or another suitable broadband Internet connection. The Internet connection 20 provides a static IP address to each of the first and second LANs 26 and 30. A VPN server 22 handles all data received from and transmitted to the Internet connection 20. The VPN server 22 transmits all downstream data to a hub 24 (or a switch) for distributing network data to the appropriate computer 28 in the first LAN 26 or second LAN 30.

Unfortunately, the VPN 10 requires each of the first and second LANs 26 to be connected to the Internet 12 through a static IP address. Not only are static IP addresses more expensive than dynamic IP addresses, but also neither of the first and second LANs 26 can be easily moved since the static IP address service would have to be moved to another location as well.

### SUMMARY OF INVENTION

It is therefore an objective of the claimed invention to provide a roaming local area network that can be expanded through dynamic IP addresses in order to solve the above-mentioned problems.

According to the claimed invention, a roaming local area network (LAN) includes a first Internet Protocol (IP) sharing device for sharing connection to a first dynamic IP address, a first group of network devices connected to the first IP sharing device, a second IP sharing device for sharing connection to a second dynamic IP address, and a second group of network devices connected to the second IP sharing device, wherein each network device in the first and second groups of network devices has a unique virtual IP address. A host is connected to the Internet through a static IP address, and the host controls data traffic between the first group of network devices and the second group of network devices.

It is an advantage of the claimed invention that computers can easily be added to the roaming LAN through a connection to the Internet using a dynamic IP address. Thus, computers can be added to the roaming LAN at any time, and without additional cost involved to register a static IP address. Moreover, the roaming LAN only requires a single host, and does not require a server at each geographical location of the roaming LAN.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a VPN according to the prior art.

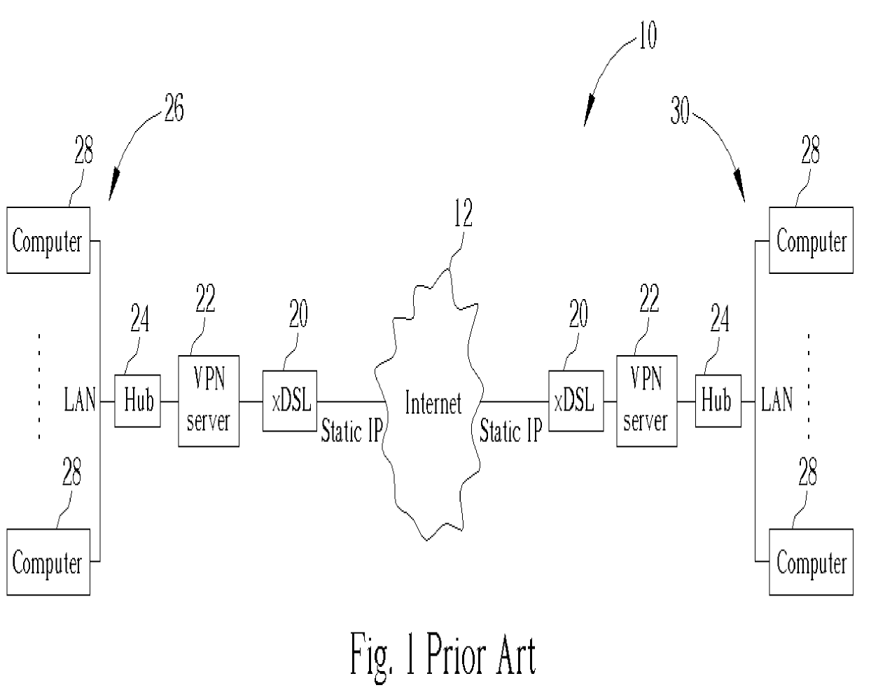

FIG. 2 is a diagram of a roaming local area network (LAN) according to a first embodiment of the present invention.

FIG. 3 is a detailed diagram of a telephone shown in FIG. 2.

FIG. 4 is a diagram of a roaming LAN according to a second embodiment of the present invention.

### DETAILED DESCRIPTION

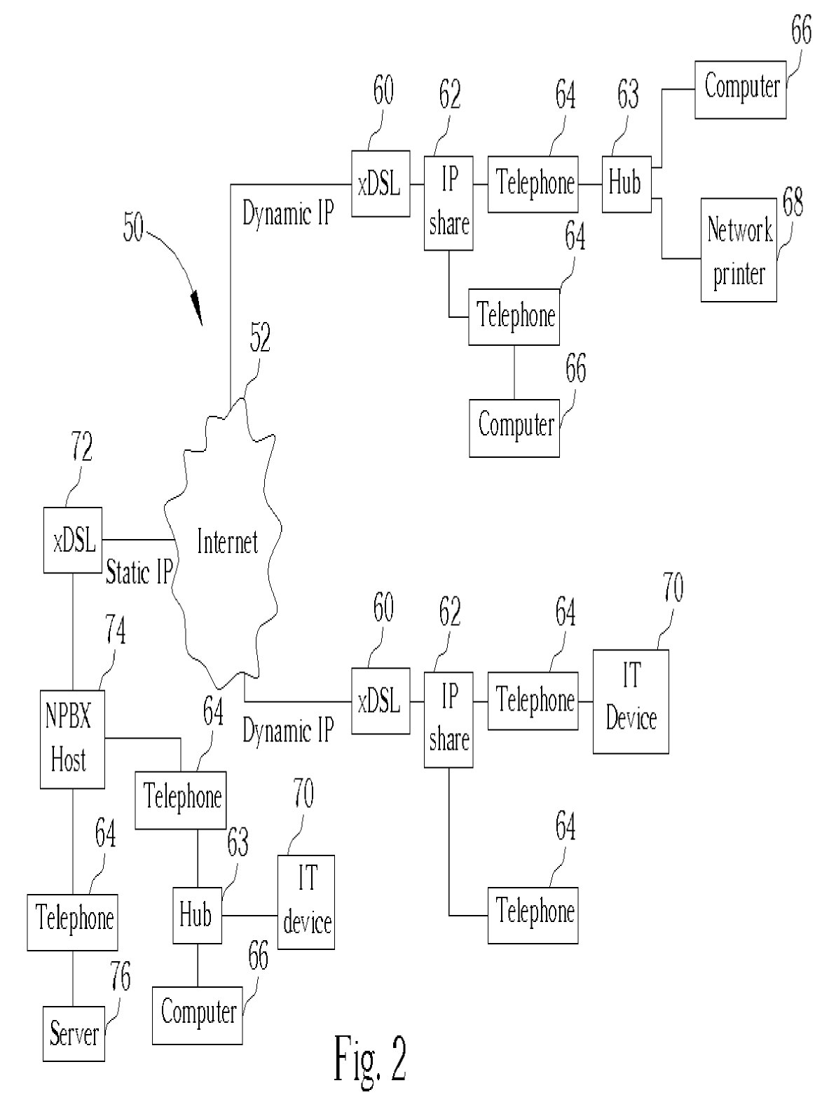

Please refer to FIG. 2. FIG. 2 is a diagram of a roaming local area network (LAN) 50 according to a first embodiment of the present invention. Unlike the VPN 10 of the prior art, a network device only needs an Internet connection 60 providing a dynamic IP address in order to be added to the roaming LAN 50. Therefore, without the restriction of needing a static IP address, network devices can quickly and easily be added to the roaming LAN 50 from anywhere in the world. All network devices will be able to communicate with network devices at other geographic locations through the Internet 52.

Each network device is connected to the roaming LAN 50 through an Internet connection 60, such as an xDSL connection or another suitable broadband Internet connection. An IP sharing device 62 containing a hub or switch is used to share the Internet connection 60 with each network device connected to the IP sharing device 62. As shown in FIG. 2, two pairs of Internet connections 60 and IP sharing devices 62 are used to connect several network devices to the roaming LAN 50 via the Internet 52. Referring to FIG. 2, a topmost IP sharing device 62 shares the Internet connection 60 with two telephones 64. Each telephone 64 is capable of placing a phone call over the Internet 52. A hub 63 is connected to one of the telephones 64 for sharing the Internet connection 60 with both a computer 66 and a network printer 68. The other telephone 64 is connected to another computer 66. A bottommost IP sharing device 62 in FIG. 2 shares the Internet connection 60 with two telephones 64 and an information technology (IT) device 70 connected directly to one of the telephones 64. The IT device 70 is a general name for any computer, network printer, network appliance, etc.

A network private branch exchange (PBX) host 74 is connected to the Internet 52 through another Internet connection 72, which provides a static IP address. The network PBX host 74 provides telephone service to each of the telephones 64. Two telephones 64 are connected to the network PBX host 74, and the network PBX host 74 is also used to coordinate all data transmitted and received in the roaming LAN 50. This functions just like anEan EthernetC-base Switch HUB or an IP-base Switch, and a server 76 (may be a Windows® 2000server) is connected directly to one of the telephones 64. All the other IT devices can directly access this server and other IT-devices through a “network neighborhood” (the VPN is only an IP-base switch tunnel). In addition, another hub 63 is connected to the other telephone for sharing the Internet connection 72 with another computer 66 and another IT device 70.

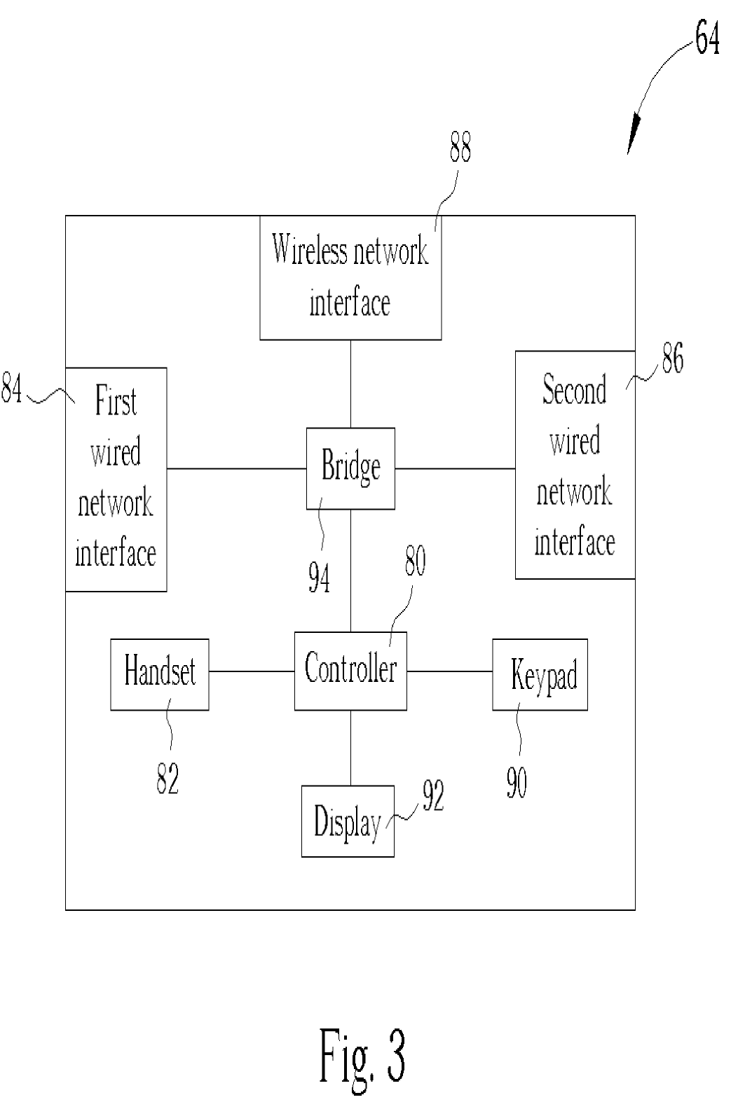

Please refer to FIG. 3. FIG. 3 is a detailed diagram of the telephone 64 shown in FIG. 2. The telephone 64 contains a controller 80 for controlling operation of the telephone 64. The controller 80 has a two-way converting function, in which the controller 80 is able to convert voice signals to the form of voice packets, and is able to restore the voice packets to the voice signals. The telephone 64 also contains a handset 82 similar to handsets of other phones. The handset 82 is used to receive voice signals from a user and then transmit the voice signals to the controller 80, or to broadcast voice signals output from the controller 80.

The telephone 64 connects to the roaming LAN 50 through a first wired network interface 84. The first wired network interface 84 preferably has an RJ12 female connector, although other connectors may be used as well. The first wired network interface 84 communicates with the roaming LAN 50 using the IEEE 802.3 protocol. The telephone 64 also contains a second wired network interface 86 for connecting a network device such as the computer 66, the IT device 70, or the network printer 68 to the roaming LAN 50. The second wired network interface 86 preferably has an RJ45 female connector, although other connectors can also be used. The second wired network interface 86 also communicates with the roaming LAN 50 using the IEEE 802.3 protocol. In this way, the telephone 64 acts as an intermediary node that allows a network device to communicate with the roaming LAN 50 via the telephone 64.

The network PBX host 74 and the telephones 64 form an inner IP-based network through the first wired network interfaces 84 of the telephones 64. All network devices connected to the telephones 64 through the second wired network interfaces 86 form what is being referred to as a roaming LAN. The roaming LAN is said to be roaming because each of the telephones 64 can be connected to the Internet 52 anywhere that a dynamic IP address is present. A static IP address can also be used, but is not necessary when using the present invention. In addition to LAN data packets being transmitted within the roaming LAN 50, audio, voice, and control packets can also be transmitted. Audio packets can be given higher priority to ensure that the audio performance of the telephones is of sufficient quality for telephone conversations.

Instead of using the first wired network interface 84 to communicate with the roaming LAN 50, the telephone 64 can also use a wireless network interface 88 to wirelessly communicate with the roaming LAN 50 using any one of the IEEE 802.11x protocols. The wireless network interface 88 is preferably a PCMCIA slot for receiving a PCMCIA 802.11x card, but other slots or connectors may also be used such as a USB connector, a CardBus slot, a mini-PCI slot, a PCI slot, etc. Thus, the telephone 64 can be connected to the roaming LAN 50 with a wire using the first wired network interface 84 or wireless network interface 88 using the wireless network interface 88.

The telephone 64 also has a keypad 90 used for dialing the telephone 64 and utilizing the functions of the telephone 64. A display 92 is connected to the controller 80 for displaying any messages of the telephone 64. Each telephone 64 further includes a bridge 94 linked between the first wired network interface 84, the second wired network interface 86, and the wireless network interface 88 to perform transmission flow control for data sent to and received from the roaming LAN 50.

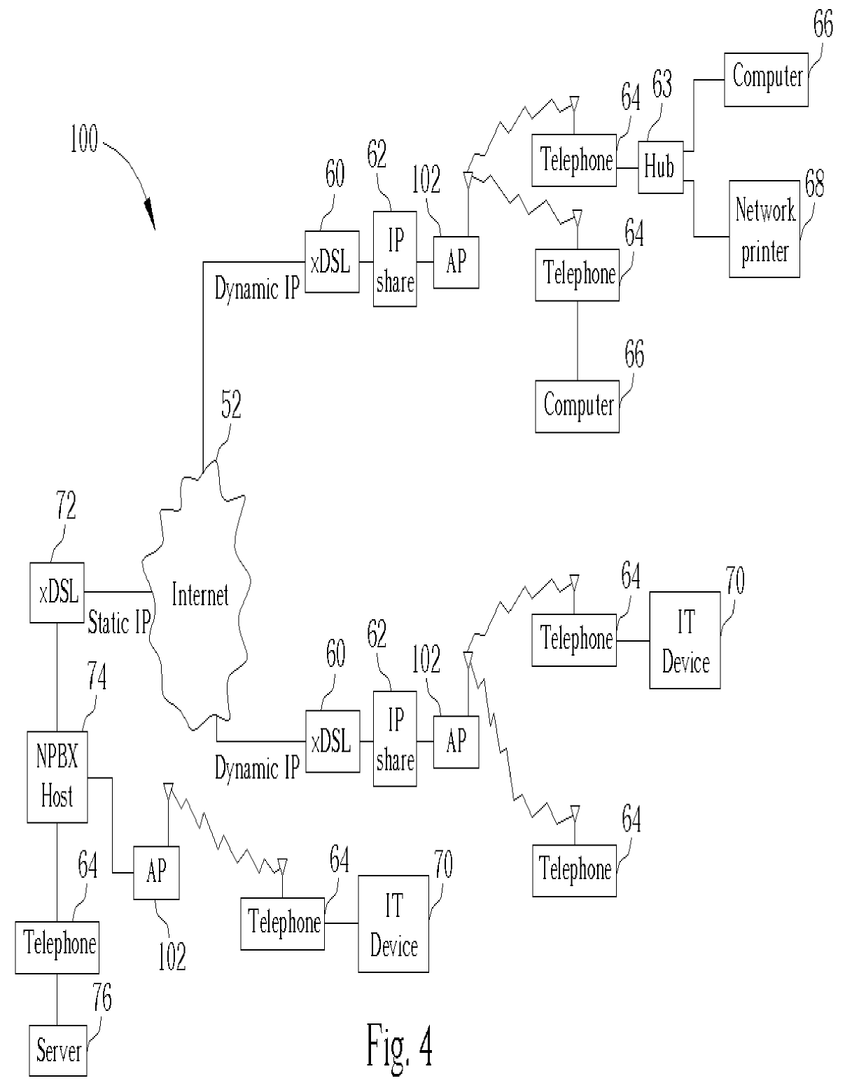

Please note that in FIG. 2, all connections between network devices are wired connections, and utilize the IEEE 802.3 protocol. Please refer to FIG. 4. FIG. 4 is a diagram of a roaming LAN 100 according to a second embodiment of the present invention. The roaming LAN 100 is similar to the roaming LAN 50 shown in FIG. 2, and the same reference numbers will be used to refer to the same parts. Instead of using wired connections to connect network devices, the roaming LAN 100 utilizes access points 102 to wirelessly connect with the network devices in the roaming LAN 100. As shown, the telephones 64, the computer 66, and the network printer 68 can all communicate with the access point 102 using at least one of the many IEEE 802.11x protocols. As before, devices connecting directly to the telephones 64 still connect to the roaming LAN 100 through a wired connection to the second wired network interface 86 of the telephones 64.

In contrast to the prior art, the present invention roaming LAN utilizes dynamic IP addresses to connect all network devices to the roaming LAN. Only the host device requires a static IP address so that the other network devices have a stable address in which to communicate with the host. Thus, computers can be added to the roaming LAN at any time, and without additional cost involved to register a static IP address. Moreover, the roaming LAN only requires a single host, and does not require a server at each geographical location of the roaming LAN.

Those skilled in the art will readily observe that numerous modifications and alterations of the device may be made while retaining the teachings of the invention. Accordingly, the above disclosure should be construed as limited only by the metes and bounds of the appended claims.

1. A roaming local area network (LAN), comprising:
a first Internet Protocol (IP) sharing device for sharing connection to a first dynamic IP address;
a first group of network devices connected to the first IP sharing device;
a second IP sharing device for sharing connection to a second dynamic IP address;
a second group of network devices connected to the second IP sharing device, wherein each network device in the first and second groups of network devices has a unique virtual IP address; and
a host connected to the Internet through a static IP address, the host capable of controlling data traffic between the first group of network devices and the second group of network devices.

2. The roaming LAN of claim 1 wherein a first network device in the first group of network devices is a telephone.

3. The roaming LAN of claim 2 wherein a second network device in the first group of network devices is directly connected to the telephone for establishing a connection to the LAN through the telephone.

4. The roaming LAN of claim 3 wherein the telephone comprises an RJ45 connector for connecting to the second device through a network cable according to the IEEE 802.3 protocol.

5. The roaming LAN of claim 2 wherein the second device is a computer.

6. The roaming LAN of claim 2 wherein the first IP sharing device comprises a switch or hub for sharing the first dynamic IP address with the first group of network devices.

7. The roaming LAN of claim 6 wherein the telephone comprises an RJ12 connector for connecting the telephone to the first IP sharing device through a network cable according to the IEEE 802.3 protocol.

8. The roaming LAN of claim 2 wherein the first IP sharing device is connected to an access point for wirelessly sharing the first dynamic IP address with the first group of network devices.

9. The roaming LAN of claim 8 wherein the telephone communicates with the access point according to an IEEE 802.11x protocol.

10. The roaming LAN of claim 9 wherein the telephone comprises a connector selected from a group consisting of a PCMCIA slot, a USB connector, a CardBus slot, a mini-PCI slot, and a PCI slot for receiving a PCMCIA 802.11x card.

11. The roaming LAN of claim 2 wherein the host comprises a network private branch exchange (PBX) for providing telephone service to the telephone.

12. The roaming LAN of claim 11 wherein the host further comprises a server connected to the network PBX for controlling data traffic in the roaming LAN.
